(19) United States
(12) Patent Application Publication
(10) Pub. No.: US 2025/0324371 A1
(43) Pub. Date: Oct. 16, 2025

(54) METHODS, APPARATUSES AND SYSTEMS FOR PRIMARY SYNCHRONIZATION SIGNAL-BASED MEASUREMENT AND REPORTING

(71) Applicant: InterDigital Patent Holdings, Inc., Wilmington, DE (US)

(72) Inventors: Patrick Svedman, Stockholm (SE); Tariq Elkourdi, Belleville, NJ (US); Ravikumar Pragada, Warrington, PA (US)

(21) Appl. No.: 18/634,235

(22) Filed: Apr. 12, 2024

(51) Int. Cl. H04W 56/00

(52) U.S. Cl. CPC H04W 56/001

(57) ABSTRACT

In an embodiment, a method, implemented in a WTRU comprises: receiving a first message comprising information indicating a primary synchronization signal (PSS) time period for a synchronization frequency, a set of segments within the PSS time period, one or more segment-based events criteria, and a PSS-based reporting configuration, wherein a segment of the set of segments comprises a set of time offsets; determining one or more PSS measurement values for the set of segments; determining, a subset of segments based on at least one PSS measurement value of the one or more PSS measurement values; and transmitting a second message to a network based on the at least one PSS measurement value satisfying at least one of the one or more segment-based events criteria, wherein the second message is transmitted according to the PSS-based reporting configuration, wherein the second message comprises a PSS-based measurement information.

### FIELD OF THE INVENTION

The present disclosure is generally directed to methods and procedures for primary synchronization signal-based measurement and reporting in non-standalone single carrier-frequency domain equalization systems.

### BACKGROUND

A single carrier-frequency domain equalization (SC-FDE) sub-THz system may bring the following unique aspects from a synchronization signal block (SSB)/radio resource management (RRM) measurements perspective: (i) in SC-FDE, signals may need to be multiplexed in time-domain due to lack of frequency division multiplexing (FDM); (ii) power consumption at a user equipment may be a bigger challenge in sub-THz spectrum with very wide channel bandwidths. This may imply that a synchronization signal with low symbol rate (narrow bandwidth) would be beneficial; (iii) sub-THz system may require a significantly larger number of SSBs/beams for coverage resulting in longer time for beam sweeping for synchronization and RRM measurement; (iv) given the properties of sub-THz communications, non-standalone (NSA) SC-FDE may be a preferred deployment scenario, at least initially with spotty sub-THz coverage. In an NSA SC-FDE deployment, a user equipment (UE) may be connected to a PCell in a lower frequency band, e.g., FR1-3, while accessing an SC-FDE sub-THz carrier when a sub-THz SC-FDE SCell/PSCell is available.

There is a need to design efficient and useful RRM measurements for a non-standalone SC-FDE sub-THz carrier taking their unique characteristics into account.

### SUMMARY

In an embodiment, a method, implemented in a wireless transmit/receive unit (WTRU), may comprise a step of receiving a first message comprising information indicating a primary synchronization signal (PSS) time period for a synchronization frequency, a set of segments within the PSS time period, one or more segment-based events criteria, and a PSS-based reporting configuration, wherein a segment of the set of segments comprises a set of time offsets. The method may comprise a step of determining one or more PSS measurement values for the set of segments. The method may comprise a step of determining, a subset of segments from the set of segments based on at least one PSS measurement value of the one or more PSS measurement values, wherein the at least one PSS measurement value is associated with the subset of segments; and a step of transmitting a second message to a network based on the at least one PSS measurement value associated with the subset of segments satisfying at least one of the one or more segment-based events criteria, wherein the second message is transmitted according to the PSS-based reporting configuration, wherein the second message comprises a PSS-based measurement information, and wherein the PSS-based measurement information indicates the subset of segments and the at least one PSS measurement value associated with the subset of segments. The segment may further comprise a set of frequency offsets.

The one or more PSS measurement values may comprise one or more power values of one or more PSS peaks that occurred during at least one segment of the set of segments, and wherein the at least one of the one or more segment-based events criteria comprises a highest value of at least one power value of the one or more power values, wherein the at power value corresponds to a respective at least one PSS peak of the one or more PSS peaks satisfies a first threshold.

The one or more PSS measurement values may comprise a total power value of the PSS during at least one segment of the set of segments, and wherein the at least one of the one or more segment-based events criteria comprises the total power value of the PSS satisfies a second threshold.

The method may comprise a step of determining the total power value of the PSS by summing a plurality of power values of a plurality of PSS peaks above a third threshold.

The at least one PSS measurement value associated with the subset of segments may comprise a plurality of PSS measurement values associated with a plurality of the subset of segments, and wherein transmitting the second message to the network may comprise transmitting the second message to the network based on the plurality of PSS measurement values satisfying the at least one of the one or more segment-based events criteria.

The step of determining one or more PSS measurement values may comprise a step of performing PSS detection during the PSS time period for the synchronization frequency; and a step of determining the one or more PSS measurement values based on the PSS detection. The step of determining the subset of segments may comprise a step of determining the subset of segments based on the one or more PSS measurements values.

The one or more PSS measurement values may comprise any of one or more PSS peaks with corresponding power values, one or more time offsets in relation to a start of the PSS time period, one or more frequency offsets in relation to the synchronization frequency, and one or more PSS sequence indexes.

The step of performing PSS detection may comprise a step of determining one or more PSS detection values, wherein the information further indicates a set of PSS filtering thresholds. The method may comprise a step of determining a PSS filtering threshold and one or more filtered PSS detection values based on the one or more PSS detection values, wherein the one or more filtered PSS detection values correspond to a respective one or more of the one or more PSS detection values that are above the PSS filtering threshold; and a step of determining the subset of the set of segments and the one or more PSS measurement values based on the filtered PSS detection values. The PSS-based measurement information may indicate the PSS filtering threshold.

The information may indicate a configuration associated with the set of segments, wherein the configuration associated with the set of segments may comprise any of configuration information indicating the set of segments, a first time-frequency segment corresponding to a positive frequency offset from the synchronization frequency, and a second time-frequency segment corresponding to a negative frequency offset from the synchronization frequency.

In an embodiment, a wireless transmit/receive unit (WTRU) comprising a processor, a transmitter, a receiver and a memory, may be configured to receive a first message comprising information indicating a primary synchronization signal (PSS) time period for a synchronization frequency, a set of segments within the PSS time period, one or more segment-based events criteria, and a PSS-based reporting configuration, wherein a segment of the set of segments comprises a set of time offsets. The WTRU may be further configured to determine one or more PSS measurement values for the set of segments. The WTRU may be further configured to determine, a subset of segments from the set of segments based on at least one PSS measurement value of the one or more PSS measurement values, wherein the at least one PSS measurement value is associated with the subset of segments; and to transmit a second message to a network based on the at least one PSS measurement value associated with the subset of segments satisfying at least one of the one or more segment-based events criteria, wherein the second message is transmitted according to the PSS-based reporting configuration, wherein the second message comprises a PSS-based measurement information, and wherein the PSS-based measurement information indicates the subset of segments and the at least one PSS measurement value associated with the subset of segments.

### BRIEF DESCRIPTION OF THE DRAWINGS

A more detailed understanding may be from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is an example of a block diagram illustrating a single carrier-frequency domain equalization (SC-FDE) block;

FIG. 3 is an example of a system diagram illustrating an SC-FDE transmitter and receiver;

FIG. 4 is an example of a block diagram illustrating two separate measurement configurations for a primary synchronization signal (PSS) and a secondary synchronization signal (SSS);

FIG. 5 is an example of a block diagram of a primary synchronization signal-measurement timing configuration (PSS-MTC) time frequency binning;

FIG. 6 is an example of a system diagram of Transmission and Reception block for SC-FDE;

FIG. 7 is an example of a diagram of a structure of a measurement configuration according to one embodiment;

FIG. 8 is a frequency diagram illustrating an example of WTRU determination of Cell IDs based on a network configuration of PSS bins with respect to PSS sequences according to one embodiment;

FIG. 9 is a frequency diagram illustrating an example of WTRU determination of Cell IDs based on a network configuration of PSS bins with respect to PSS sequences according to another embodiment;

FIG. 10 is a timing diagram illustrating an example of WTRU determination of time bin location based on PSS peak location according to one embodiment;

FIG. 11 is a block diagram illustrating an example of a PSS measurement model according to one embodiment;

FIG. 12 is a timing diagram illustrating an example of a PSS bin based pre-L3 filtering measurement selection according to an embodiment;

FIG. 13 is a timing diagram illustrating an example of a PSS sequence based pre-L3 filtering measurement selection based on maximum value for each PSS peak according to an embodiment;

FIG. 14 is a timing diagram illustrating an example of a WTRU Rx beam based pre-L3 filtering measurement selection according to an embodiment;

FIG. 15 is a timing diagram illustrating an example of a configuration of a set of time bins within a PSS MTC window according to an embodiment; and

FIG. 16 is a flow chart diagram illustrating an example of a method, implemented in a WTRU, for reporting PSS measurements, according to an embodiment.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

Hereinafter, “a” and “an” and similar phrases are to be interpreted as “one or more” and “at least one”. Similarly, any term which ends with the suffix “(s)” is to be interpreted as “one or more” and “at least one”. The term “may” is to be interpreted as “may, for example”.

A sign, symbol, or mark of forward slash “/” is to be interpreted as “and/or” unless particularly mentioned otherwise, where for example, “A/B” may imply “A and/or B”.

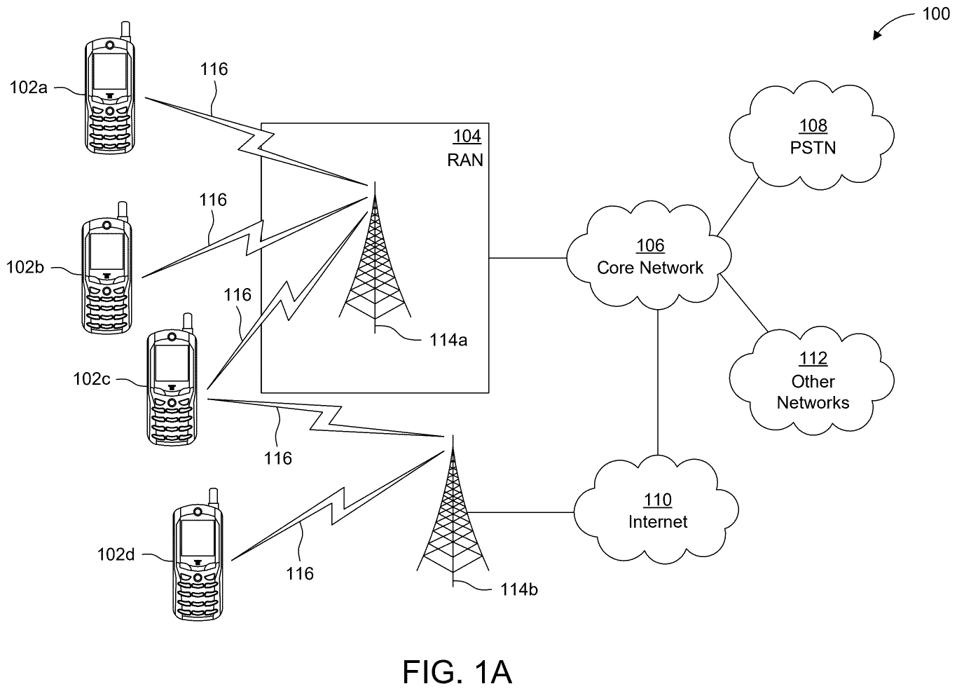

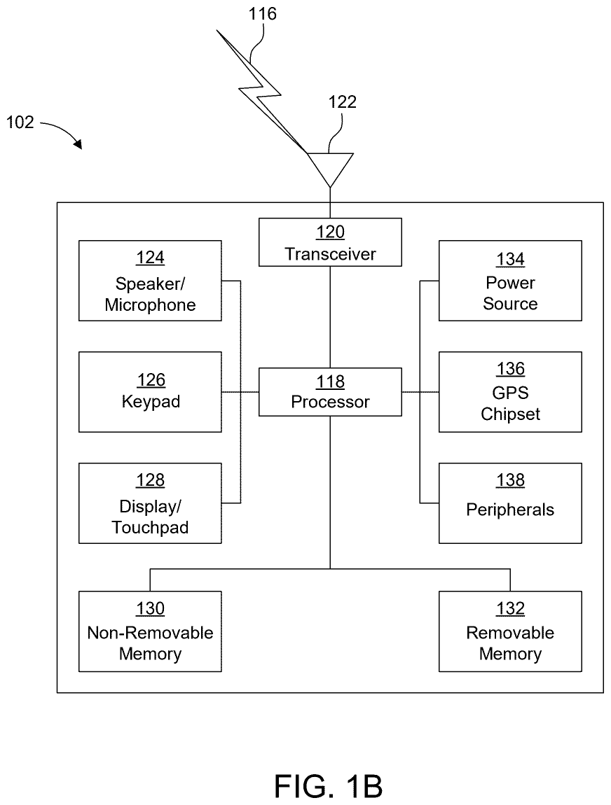

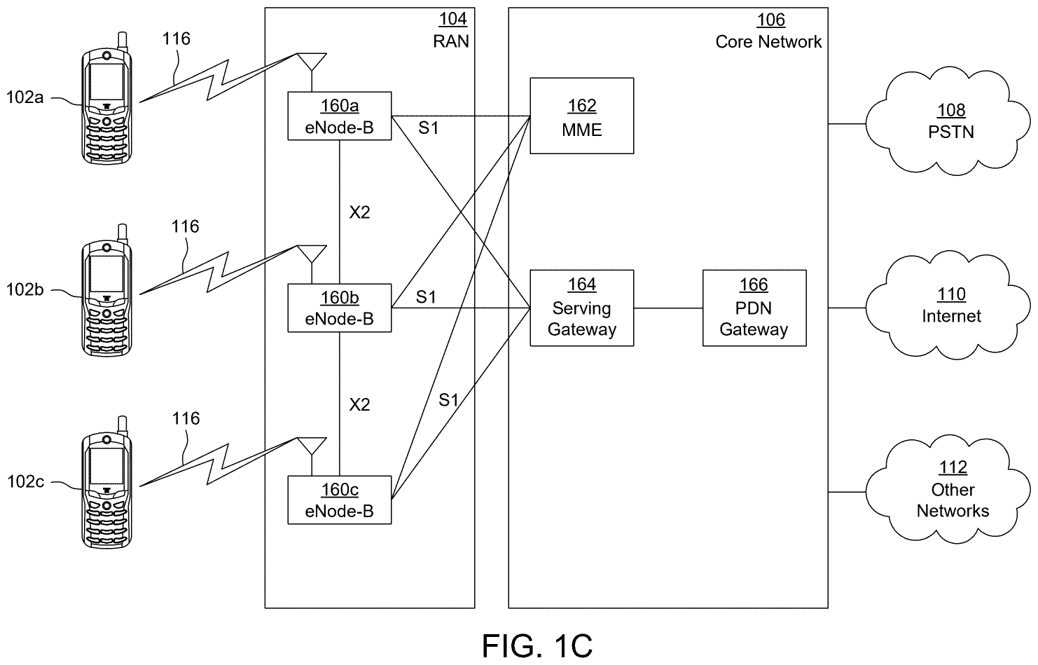

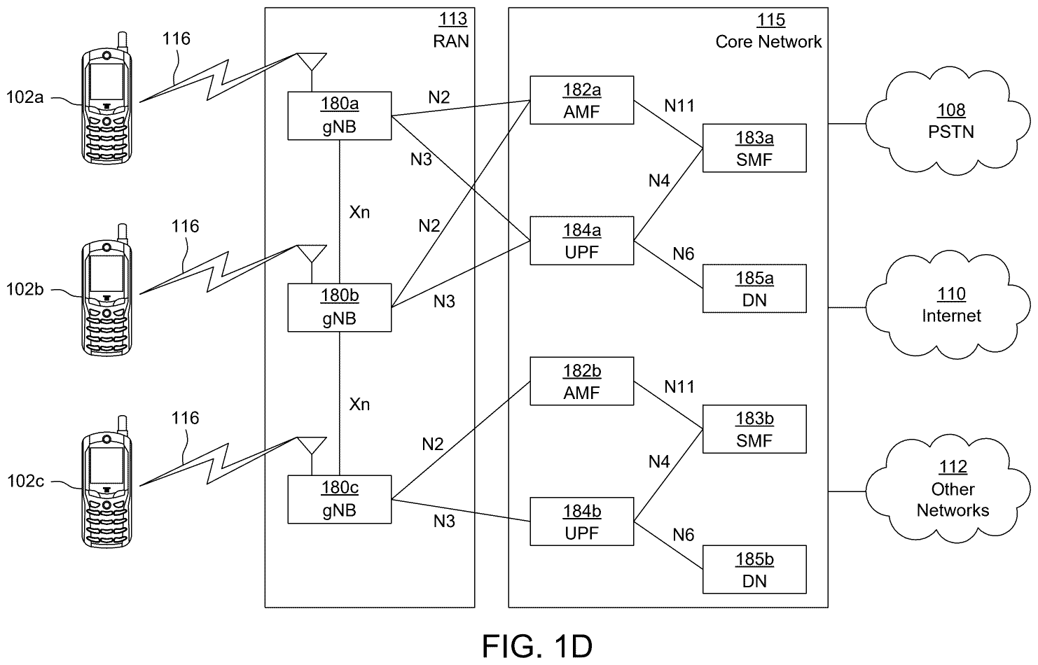

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite.

The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and maybe configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signalling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast Fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications, such as machine-type communications devices in a macro coverage area. Machine-type communications devices may have certain capabilities, for example, limited capabilities including support for (e.g., only support for) certain and/or limited bandwidths. The machine-type communications devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signalling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device (e.g., a network node) may be directly coupled to another device for purposes of testing and/or may performing testing using over-the-air wireless communications.

The one or more emulation devices may perform the one or more, including all, functions while not being implemented/deployed as part of a network node (e.g., wired and/or wireless communication network). For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In 5G NR, when a device starts initial access or decides to transition from idle/inactive state to active state, it may search for synchronization signal (SS)/Physical broadcast channel (PBCH) blocks (SSBs) which are periodically transmitted by the network. A SS/PBCH block may include a primary synchronization signal (PSS), a secondary synchronization signal (SSS) and physical broadcast channel (PBCH). It may occupy four OFDM symbols in the time domain and 240 subcarriers in the frequency domain. The SSBs in a cell may be transmitted in a time-multiplexed pattern, e.g., by transmitting different SSBs on different beams in a beam sweeping fashion. The time-multiplexed set of SSBs is sometimes referred to as an SS burst set. The SSBs in the time-multiplexed set may be periodically transmitted, with a periodicity of for example 5, 20, or 80 milliseconds (ms). The maximum number of time multiplexed SSBs within an SS burst set can be up to four for frequencies below 3 gigahertz (GHz), or eight for frequencies between 3 GHz and 7 GHz or 64 for frequencies above 7 GHz (FR2). Time domain location of SSB may be different for different SSB numerologies. Each SSB may carry an SSB index to indicate the relative location of the SSB to the half frame boundary. The network may transmit only a subset of all supported SSBs. The device can be informed of which SSBs are transmitted via broadcast or dedicated RRC signalling.

In new radio (NR), there are 3 PSS sequences (same as in LTE) with corresponding PSS sequence identifiers (Ids). NR PSS may be generated by using a BPSK modulated m-sequence of length 127. M-sequence is used to address time/frequency offset ambiguity problem encountered in Zadoff-Chu sequence used in LTE. PSS may be used for coarse time/frequency synchronization. The PSS sequence Id may also be one of the factors determining physical cell ID (PCI). A WTRU implementation may run parallel and/or sequential correlators to detect PSS, with different time- and frequency offsets.

There are 336 SSS sequences in NR with corresponding SSS sequence Ids. After detecting PSS, at least the coarse timing and frequency of SSS may be known, given that the WTRU may assume that PSS and SSS may be transmitted on the same antenna port. If an SSS is detected, the PCI can be determined. The PCI may be needed to demodulate PBCH, e.g., to determine the frequency-domain position of PBCH demodulation reference signal (DMRS).

The SSB index (0-3, 0-7, or 0-63, depending on frequency range) may be derived by the WTRU as two parts: an implicit part encoded in the PBCH DMRS sequence and in the scrambling applied to the PBCH and an explicit part included in the PBCH payload.

Single carrier with frequency domain equalization (SC-FDE) may use a single carrier waveform that, compared to orthogonal frequency-division multiplexing (OFDM), may avoid an inverse discrete Fourier transformation (IDFT) operation at transmitter, and thereby improved peak to average power ratio (PAPR) characteristics, robustness to phase noise and low-resolution ADC/DAC. Although both OFDM and SC-FDE may use a single discrete Fourier transformation (DFT) block and a single IDFT block (same overall complexity), the SC-FDE IDFT operation may occur at the receiver. The higher power efficiency of the SC-FDE transmitter may translate into an increase in cell coverage area. Due to its single carrier nature, SC-FDE may not provide means for frequency multiplexing (within an SC-FDE carrier) although other multiplexing means (time, space, polarization, etc.) are still applicable.

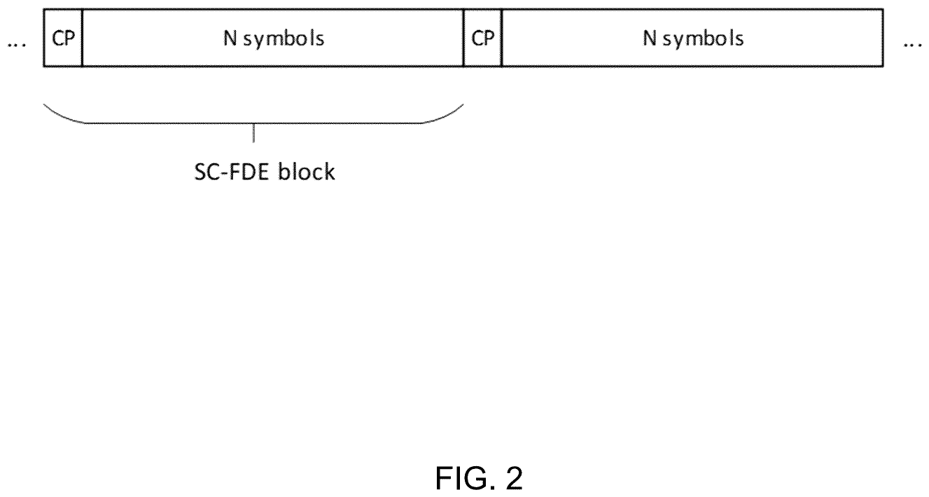

As shown in FIG. 2, to enable frequency domain equalization using DFT/IDFTc similar to OFDM, SC-FDE systems may typically use a cyclic prefix (CP) with a duration that is longer than the channel. N symbols plus a CP forms an SC-FDE block.

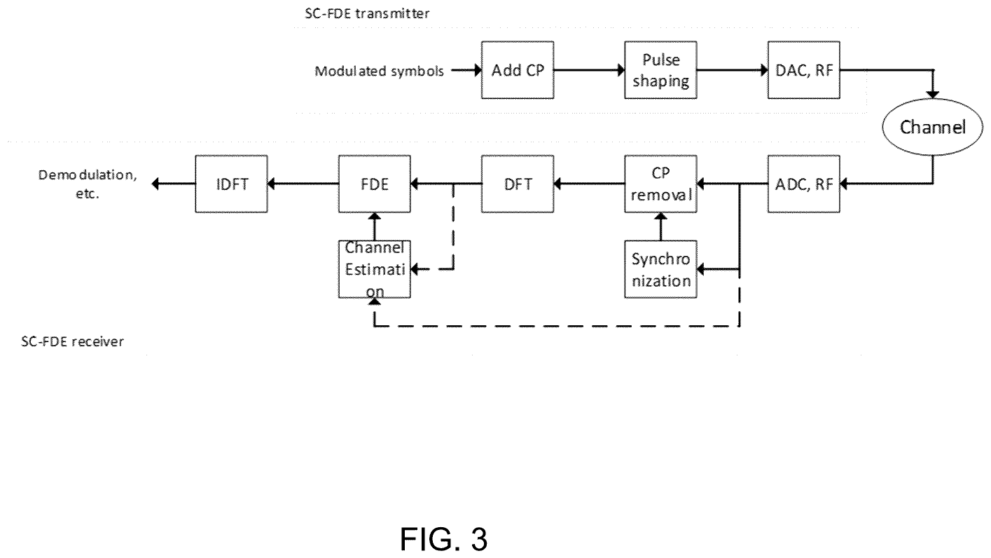

As shown in FIG. 3, in OFDM, demodulation and detection may be performed in the frequency domain. In SC-FDE, demodulation and detection may be performed in the time domain, after FDE. An exemplary SC-FDE transmitter and receiver is illustrated in FIG. 3. The DFT and IDFT size should preferably match the number of symbols in the SC-FDE block (N in FIG. 2).

A WTRU may need measurement gaps (MG) as it cannot perform inter-frequency or inter-radio access technology (RAT) measurement while transmitting/receiving. Inter-frequency measurement may be required if it is performed outside of WTRU's current active Bandwidth Parts (BWP). The network may configure the measurement gaps for the WTRU via radio resource control (RRC) signaling. During measurement gap, the WTRU may be not required to receive or transmit in the serving cell. There may be two types of measurement gaps: per-WTRU and per-RF. Per RF measurement gap may have two gap patterns, FR1 gap and FR2 gap. Per-RF gaps may be required due to separate RF chain support by WTRU. When either gap FR1 or gap FR2 is configured, gap WTRU can't be configured for the WTRU (e.g., gap WTRU can be used for measurements in both FR1 and FR2.)

The network may inform the WTRU about the timing of neighbor cell SSBs via SSB measurement timing configuration (SMTC). SMTC may be contained within the MG. SMTC periodicity can be longer than the SSB periodicity, e.g., if channel conditions are good, mobility is low, etc.

A set of predefined measurement reporting comprising mechanisms called “events” can be configured. WTRU may measure serving and neighbor cell quantities and compare with the threshold, offset, etc., for the event. The report quantity/the trigger for event can be reference signal received power (RSRP), reference signal received quality (RSRQ) or signal-to-noise and interference ratio (SINR).

The radio resource overhead of a narrowband synchronization signal may be significantly higher in SC-FDE systems, since a narrowband synchronization signal may prevent transmission of other signals over the whole bandwidth for the duration of the synchronization signal transmission. In contrast, in OFDM-based systems, other transmissions can be frequency multiplexed during narrowband synchronization signal transmission, thereby reducing the effective overhead of the OFDM-based synchronization signals.

It may be assumed a similar PSS bandwidth and PSS duration for an SC-FDE based system as an OFDM-based system (as in 5G NR). As non-limited example, PSS/SSS/PBCH overhead for SC-FDE may be in the order of 12 time more than that of the NR CP-OFDM system (e.g., 16.5% system overhead for SC-FDE vs 1.3% for CP-OFDM).

Furthermore, the long duration of a PSS/SSS/PBCH burst means that a WTRU may need to perform PSS detection during a longer time window (e.g., time period), resulting in higher WTRU power consumption, etc. Therefore, there is a need for a flexible SC-FDE synchronization signal bandwidth design that achieves higher spectrum utilization and reduces overhead.

For example, consider a system with narrowband PSS and wideband SSS/PBCH. Such system would allow the WTRU to consume less power for narrowband PSS based cell search due to lower sampling rate during the PSS detection. Less time would also be required for wideband SSS/PBCH transmission. The wideband SSS/PBCH would also allow for higher synchronization and measurement accuracy for SSS-based measurement.

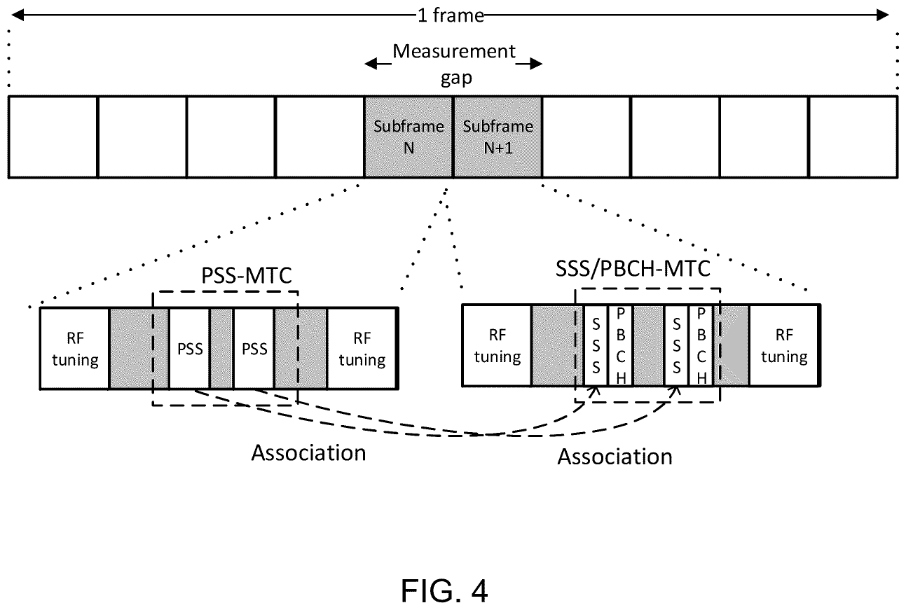

In NR, PSS, SSS and PBCH may be transmitted together in an SSB. For the considered single-carrier system, however, it may be beneficial to reduce the symbol rate switching between narrowband PSS and wideband SSS/PBCH by introducing a narrowband PSS burst (in a PSS measurement timing configuration (MTC) window) and a wideband SSS/PBCH burst (in an SSS MTC) that may be separate in time. Furthermore, a separate PSS burst (in a PSS-MTC window) may be more compact in time and thereby give a shorter time during which PSS detection needs to be performed. FIG. 4 shows an example of two separate PSS and SSS bursts, each with its own MTC.

Since it's assumed that PSS and SSS may be separate in time, it may be beneficial to configure a WTRU with only a PSS-MTC, but not an SSS-MTC, for instance for initial RRM measurements on an SC-FDE carrier. Not configuring an SSS-MTC may shorten the WTRU measurement gap, may reduce the WTRU measurement effort, as well as allowing the network to stop transmitting SSS/PBCH during some periods. Hence, the problem is how to design PSS-based measurement and reporting that is useful for the network? PSS-based reporting may be different from legacy SSB-based RRM reporting since a PSS measurement value cannot be reported together with the associated PCI or beam/SSB index.

In the various embodiments below, a concept of bins is used to describe the process of dividing a continuous time interval such as PSS-MTC and/or a frequency band centered around a reference frequency into smaller discrete time and/or frequency fragments/segments called bins or sub-windows. Bin type may describe the domain in which binning is performed, namely, time, frequency, or time/frequency. In the various embodiments below, the term bin is used to describe any of these types, except in examples which explicitly describe a specific type. A bin may comprise a set of time offsets and/or a set of frequency offsets.

WTRU PSS detection and/or measurement may result in a set of correlation values for a set or range of time offsets and frequency offsets. A correlation value for a time offset and a frequency offset may correspond to a correlation, e.g., cross correlation, between a received signal and a PSS signal, which is based on a PSS sequence. To determine a correlation value for a time offset and a frequency offset, the WTRU may apply the time offset and/or frequency offset to the received signal and/or the PSS signal. The time offset may be in relation to a reference time, e.g., the start of an MTC window. The frequency offset may be in relation to a reference frequency, e.g., the synchronization frequency at the WTRU side. The terms PSS RSRP peak, path, PSS path, detection value, measurement value, etc., may refer to correlation value, magnitude of a correlation value, or similar. A path detected by a WTRU may correspond to a time offset and/or frequency offset. The detected path may correspond to a PSS peak with the time offset and/or frequency offset. A correlation value, power value, or peak may be represented in a linear scale, e.g., Watt (W) or milliwatt (mW), or in dB scale, e.g., dBm. A WTRU with multiple Rx beams may determine correlation values for different Rx beams, e.g., based on signal reception using different Rx beams. Hence, the WTRU may determine multiple correlation values for a time offset and a frequency offset, wherein the multiple values correspond to different Rx beams.

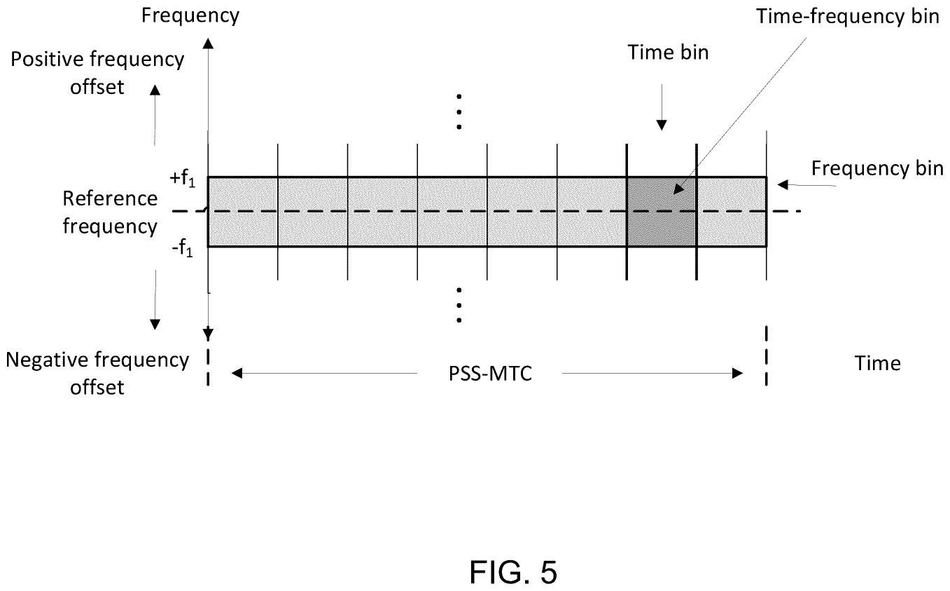

As shown in FIG. 5, as a non-limiting example, a frequency bin may correspond to frequency offsets between a positive (or negative) offset f1 (or −f1) and positive (or negative) infinity. A frequency bin may span frequency offsets between −f₁ and +f₂, between +f₁ and +f₂, or between −f₁ and −f₂.

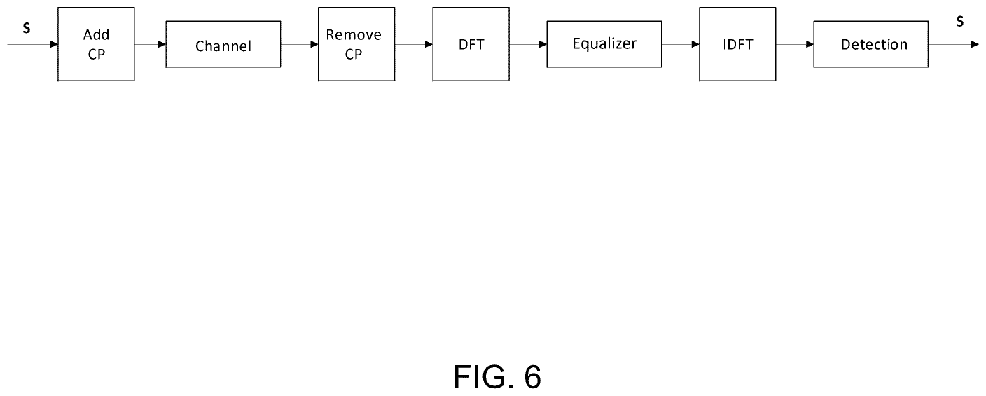

About SC-FDE based transmission and reception, at the SC-FDE transmitter, groups of Log₂M data bits may be mapped into complex symbols in an M-ary complex constellation. Then, N symbols may be grouped into blocks and sent to the encoder. A cyclic prefix (CP) may be added to each block of the grouped N symbols, by prefixing a copy of its last N_{CP} symbols. This may prevent Inter-block interference (IBI) but may waste bandwidth and may be energy inefficient. It may introduce short term periodicity which may make a linear convolution of a channel impulse response look like a circular convolution. Circular convolution in the time domain may useful as it may translate into multiplication in the frequency domain. As illustrated by the block “Add CP” on FIG. 6, a CP extended block may be added to each block of grouped N symbols. The CP extended blocks may be fed to a parallel to serial converter, a digital to analog converter, frequency up-converter and a filter before it may be transmitted over a wireless channel illustrated by the block “channel” in FIG. 6. At the receiver, the signal may be fed to a frequency down-converter, a filter and analog to digital converter. The output sequence of samples may be grouped into blocks again. For each block grouped N symbols, CP may be discarded, as illustrated by the block “Remove CP” on FIG. 6, and the remaining samples may be sent to an FFT block (DFT block on FIG. 6) for conversion to frequency domain. Then, a frequency domain equalizer (“Equalizer” block on FIG. 6) may be used to compensate for channel distortion. The output symbols may be fed to an IFFT block (“IDFT” block on FIG. 6) for conversion to the time domain.

SC-FDE transmitted signal Bandwidth is proportional to the symbol rate. The SC-FDE block duration depends on symbol rate, assumed receiver DFT/IDFT size, and CP. The SC-FDE block duration may be given by the following equation:

$$block duration = \frac{DFT size}{symbol rate} + CP duration \qquad ( 1 )$$

The CP duration should accommodate communication channel time dispersion, time synchronization errors, etc. It may consist of an integer number of symbols that is less than the assumed receiver DFT/IDFT size. For a fixed CP duration (in seconds) and DFT/IDFT size, CP overhead may grow with symbol rate, for example, with shorter SC-FDE block duration.

About synchronization raster for SC-FDE based cell search and synchronization, a synchronization signal may be transmitted on a certain frequency, e.g., the center frequency of the signal, and a certain signal bandwidth. In order to limit the number of center frequency hypotheses, a WTRU may assume that a synchronization signal is transmitted on a frequency that belongs to a synchronization raster. A synchronization raster may be a set of frequency points, e.g., corresponding to center frequencies, that may be configured to a WTRU (or defined in a specification).

A synchronization raster may comprise a set of frequency points for a frequency band that are uniformly or non-uniformly spaced (separated) within the band. The frequency spacing may be the same in different bands, e.g., adjacent bands, or different. A WTRU may determine a set of synchronization raster points by using an equation, where the parameters in the equation may be defined in a specification or configured. Alternatively, the WTRU may determine a set of synchronization raster points from a table, that may be defined in a specification or configured to the WTRU.

In some cases, a synchronization signal may be transmitted with a center frequency that is offset from a synchronization raster frequency, where the offset may be configurable and/or belong a predefined set of offsets (e.g., 1, 2, 3, or 4 offsets, potentially including offset 0).

The synchronization raster and synchronization raster point concepts may be used in various embodiments herein. However, these terms could also be understood to represent, more generally, a particular carrier frequency, which does not necessarily lie on a synchronization raster, for example, as represented by an absolute radio-frequency channel number (ARFCN).

The term synchronization frequency is used herein to represent a frequency, e.g., carrier frequency, on which a WTRU may perform cell search, synchronization signal detection, synchronization signal based measurements, synchronization, etc. A synchronization frequency may correspond to a synchronization raster point, an ARFCN, etc., e.g., as discussed above.

A WTRU performing an operation on a synchronization frequency may include/comprise the WTRU performing an operation on the synchronization frequency plus/minus a frequency offset that is typically small in relation to the synchronization frequency. A synchronization signal may be received slightly off the synchronization frequency due to Doppler shifts, imperfect oscillators, etc.

About PSS in an SC-FDE system, a WTRU may assume any of the following in various combinations: (i) one or more PSS sequences may be defined; (ii) in some cases, the different PSS sequences may be based on different cyclic shifts of a single sequence. The different PSS sequences may be associated with different parameter values, e.g., different index values. In some cases, the parameter value may be directly used to determine the cyclic shift; (iii) in some cases, the different PSS sequences may be generated using different initialization values, e.g., for a shift register or a pseudo-random sequence generator; (iv) the modulated symbols may be pulse shaped using a pulse or a filter, which may be associated with one or more parameters, such as a roll off factor. The roll off factor may have a value between 0 and 1, where small roll off factor may correspond to steeper roll off in the pulse frequency response, while resulting in higher peak-to-average-power ratio (PAPR). Example pulses include raised cosine, such as the root raised cosine.

In some cases, the WTRU may use a matched filter in its receiver, where the filter may be matched to the pulse/filter at the transmitter, e.g., a root raised cosine filter; (v) the block of PSS symbols may be prepended or appended with a CP, a unique word (a predefined sequence of symbols), or zeros. In some cases, PSS symbols may be not prepended or appended in such a way. Henceforth, the term CP will be used to denote a prepended or appended CP, unique word, zeros, or similar; (vi) the baseband symbols, including CP, if any, may be up converted and transmitted on the PSS frequency, e.g., on a synchronization raster point. The PSS symbols may be transmitted at a symbol rate, e.g., at a certain number of symbols per second. The bandwidth occupied by the PSS, e.g., the x dB bandwidth (x is for instance 3, 6, etc.), may depend on multiple factors, such as the PSS symbol rate and the used roll off factor.

In the various embodiments below, the term SSS/PBCH is used herein. It may refer to SSS and/or PBCH.

In the various embodiments below, a WTRU may report to the network. The reporting may be included in an uplink channel, such as PUSCH or PUCCH. The reporting may comprise L1, L2, or L3 signaling. The report may comprise a radio resource management (RRM) report. For example, a report may be included in an RRC message. Based on its configuration, the WTRU may report periodically, semi-persistently, or aperiodically. In the case of semi-persistent reporting, the WTRU may start to report periodically upon the reception of a reporting activation, e.g. in a corresponding downlink MAC CE. The WTRU may stop reporting periodically upon the reception of a reporting deactivation, e.g., in a corresponding downlink MAC CE. In the case of aperiodic reporting, the WTRU may report once or a few times upon reception of a reporting trigger, e.g., in a downlink control information (DCI). In various examples below, an aperiodic WTRU report is triggered by a configured event.

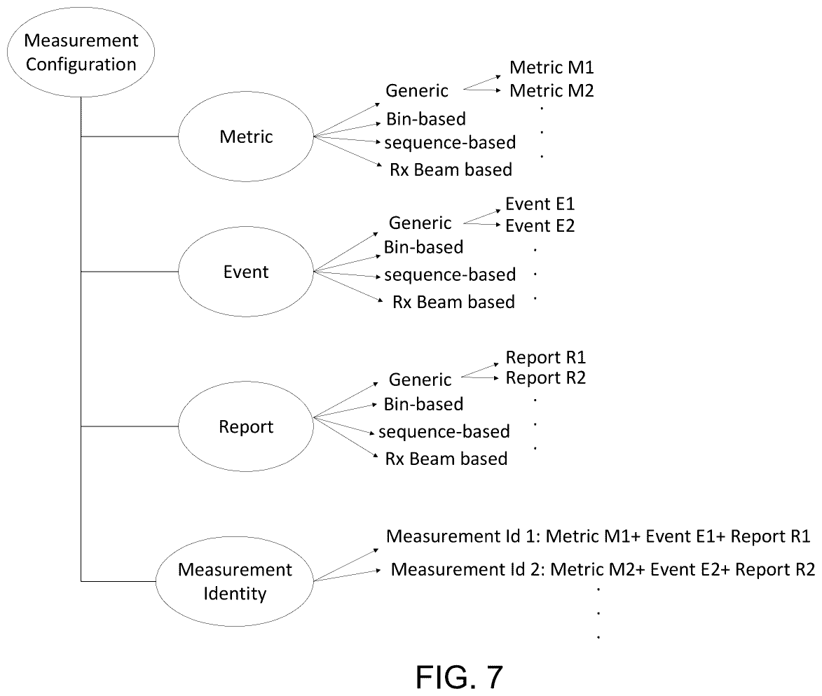

About PSS measurement metrics, events and reports, in an embodiment, the WTRU may be configured with a set of PSS measurement metrics, events and reports by the network. The measurement metric may be a quantity representing the signal strength of the received PSS signal at the WTRU. The metric may be based on a quantity such as RSRP, RSRQ or SINR. The measurement event may specify the criteria to trigger WTRU measurement reporting based on the configured metric. As shown in FIG. 7, the WTRU may be configured by the network with one or more “metric, event, report” combinations defined as measurement identities. The WTRU may receive a reporting configuration indicating the maximum number of metrics to reports. The WTRU may report one or more of these metrics up to a configured maximum number. The number of reported metrics may also depend on a configured threshold or a set of thresholds. In various embodiments below, for simplicity, RSRP term is used as an example quantity used in the measurement metric that also could be substituted by RSRQ or SINR.

Referring to FIG. 7, the following may be exemplary generic measurement metrics, triggering events and reports: (i) Metric M1: the linear average or sum over the power contributions [e.g., in W] of the PSS RSRP peaks above a certain threshold (TH_{M1}) across all PSS sequences. Metric M1 results may be a single value corresponding to the average or sum for all sequences. The threshold (TH_{M1}) may be predefined, configured, or selected by the WTRU; (ii) Event E1-1: M1 is below a certain threshold TH_{E1}. If an event E1-1 is triggered, the WTRU may be considered out of coverage of the neighbor cell. A hysteresis may be defined to prevent unnecessary frequent event triggering. A “timeToTrigger” parameter may define the time during which this criterion for the event needs to be met in order to trigger a measurement report comprising measurement information. (iii) Event E1-2: M1 is above a certain threshold TH_{E2}. If an event E1-2 is triggered, the WTRU may be considered in coverage of the neighbor cell. A hysteresis may be defined to prevent unnecessary frequent event triggering. A “timeToTrigger” parameter may define the time during which this criterion for the event needs to be met in order to trigger a measurement report comprising measurement information; (iv) Report R1: The WTRU may report metric M1 back to the network. Accordingly, the network may use this feedback from the WTRU to configure SSS MTC periodicity; (v) Metric M2: the linear average or sum over the power contributions (e.g., in W) of the PSS RSRP peaks above a certain threshold TH_{M2} for each PSS sequence. Metric M2 may result in a number of values equal to the number of PSS sequences. The threshold may be predefined, configured, selected by the WTRU etc.; (vi) Event E2: M1 is above threshold TH_{E1} and/or M2 is above threshold TH_{E2}. If event E2 is triggered, the WTRU may be considered in coverage of the neighbor cell and at least one PSS sequence has a strong RSRP. A hysteresis may be defined to prevent unnecessary frequent event triggering. A “timeToTrigger” parameter may define the time during which this criterion for the event needs to be met in order to trigger a measurement report comprising measurement information. Events based on (e.g., only) M1 may be used by the WTRU to report that it is out of network coverage. The network may use such information for energy saving purposes. Events based on M2 may be used by the WTRU to report signal quality of a neighbor cell; (vii) Report R2: The WTRU may report one or more strongest PSS RSRP peak(s) of the corresponding PSS sequence(s) from event E2 to the network.

About WTRU selection and reporting of PSS filtering threshold, in an embodiment, PSS correlation values (or value magnitudes) in time and frequency may comprise non-zero values most of which may not need to be included in the determination of PSS metrics. In this case, filtering may be useful to reduce the impact of noise and interference. A simple way of filtering is to remove or set to zero all correlation values below a threshold. The WTRU may select a suitable threshold such that the stronger peaks may be above the threshold while the smaller values in all time and frequency offsets between the stronger peaks fall below the threshold. The selection may be up to the WTRU or based on a specified rule. An example rule may be that the WTRU shall select a threshold such that at least A %, (e.g., 95%), of the correlation values may fall below the threshold. In another embodiment, the WTRU shall select a threshold at least B times the average correlation values, (e.g., twice the average correlation value).

The WTRU may indicate the selected threshold to the network. The WTRU may select a threshold from a set of PSS filtering thresholds. The network may for instance estimate a WTRU SINR based on the ratio of a reported strong peak to the reported threshold.

The WTRU may receive a configuration of the set of PSS filtering thresholds from the network or the thresholds may be pre-defined in a standard. The range of threshold values may be defined from a minimum value to a maximum value with x dB resolution, where x may be an integer. For example, for a configured set of 15 thresholds ranging from a minimum value of −140 dBm to a maximum value to 0 dBm in steps of 10 dB, the reporting range value may be 1 to 15. A reported threshold value of 15 may mean that PSS correlation values below 0 dBm are not included in a determination of a PSS measurement metric, as described below.

The WTRU may be configured to include an indication of a selected PSS filtering threshold in a PSS measurement report. The WTRU may have obtained the PSS measurement result in a report by applying the threshold that was indicated in the same report. The WTRU may indicate different PSS filtering thresholds in different PSS measurement reports (e.g. measurement information).

About PSS-MTC binning, PSS-MTC time binning may be categorized into two approaches, configured bins and WTRU-determined bin locations. The PSS-MTC time binning approach may be pre-defined or signaled to the WTRU by the network.

The WTRU may receive, from the network, an RRC configuration that may divide the PSS MTC into N continuous time bins. These continuous time bins may be (e.g., typically) equally sized with no gaps or overlap between them. In the configuration, the network may take into account the number of neighboring cells and timing of their corresponding SS bursts. In one configuration, the network may configure the WTRU with PSS MTC parameters (e.g., start time tₛₜₐᵣₜ and duration T_{PSS-MTC}) along with the number of time bins N such that the duration of each time bin may be equal to an integer number of symbols. The WTRU may determine the duration of PSS-bins according to T_{PSS-bin}=T_{PSS-MTC}/N. In another configuration, the WTRU may be configured by the network with PSS-MTC parameters and the duration of each PSS bin T_{PSS-MTC}. The WTRU may determine the number of PSS-bins according to N=T_{PSS-MTC}/T_{PSS-bin}. Alternatively, the WTRU may be configured by the network with the PSS-MTC start time, PSS-bin duration and the number of PSS bins. The WTRU may determine the PSS-MTC duration according to T_{PSS-MTC}=N·T_{PSS-bin}.

The WTRU may receive PSS with a frequency offset to the reference frequency, which may be a synchronization frequency. The frequency offset may for example be due to Doppler shift caused by WTRU movement, a carrier frequency offset, etc.

The WTRU may receive, from the network, an RRC configuration that divides frequency offsets into N̅ frequency bins. These frequency bins may be typically continuous and equally sized with no gaps or overlap between them. The frequency bins may also be unequally sized. For example, the bin corresponding to the largest positive or negative frequency offsets may cover offsets between f1 and infinity or between −f1 and -infinity, respectively. In the configuration, the speed and direction of the WTRU may be taken into account by the network. In one configuration, the WTRU may be configured by the network with PSS MTC frequency domain parameters (i.e., reference frequency f_{ref} and bandwidth F_{PSS-MTC}) along with the number of frequency bins N such that the bandwidth of each frequency bin F_{PSS-bin} may be equal to an integer number of Hertz. The WTRU may determine the bandwidth of frequency bins according to F_{PSS-bin}=F_{PSS-MTC}/N̅. In another configuration, the WTRU may be configured by the network with PSS-MTC bandwidth parameters and the bandwidth of each PSS frequency bin F_{PSS-MTC}. The WTRU may determine the number of PSS-bins according to N̅=F_{PSS-MTC}/F_{PSS-bin}. Alternatively, the WTRU may be configured by the network with the PSS-MTC reference frequency, PSS-frequency bin bandwidth and the number of PSS frequency bins. The WTRU may determine the PSS-MTC bandwidth according to F_{PSS-MTC}=N̅. F_{PSS-bin}.

The WTRU may receive an RRC configuration from the network that divides the PSS MTC time duration into N time intervals and frequency band around the reference frequency into and N frequency bins, respectively. The time and frequency configuration creates N×N̅ time-frequency bins. The WTRU may be configured with any combination of time and/or frequency configurations as described above.

In an embodiment, the WTRU may be configured by the network with the following mapping: PSS sequence, time bin index, and frequency bin index that may be mapped to a cell ID.

Accordingly, the WTRU may determine a cell ID. For example, peaks of PSS sequence 0 detected in time bin 1 and frequency bin 1 may belong to cell ID 1 and peaks of PSS sequence 1 detected in time bin 2 and frequency bin 1 may belong to cell ID 2, etc. This type of association may be based on all three parameters: PSS sequence, time bin, frequency bin; or any combination of the three parameters. For example, the WTRU may be configured by the network to determine the cell ID based on time bins only. In another embodiment, the WTRU may be configured by the network to determine the cell ID based on time bins and PSS sequences.

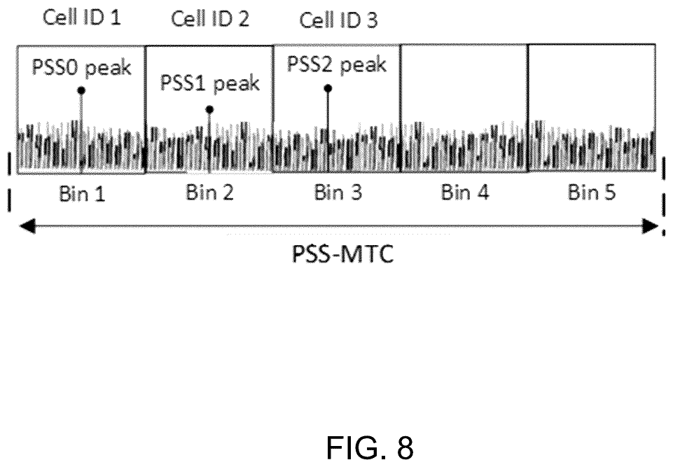

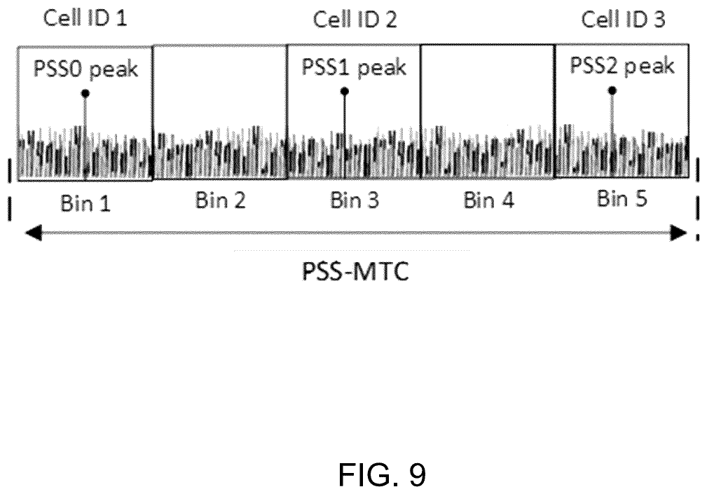

Alternatively, the network may follow a certain configuration pattern that may assist the WTRU in determining the cell ID as illustrated in FIG. 8 and in FIG. 9. Referring to FIG. 8, PSS sequences may be transmitted sequentially such that PSS sequences with even ID numbers may be transmitted in PSS bins with even index numbers, and PSS sequences with odd ID numbers may be transmitted in PSS bins with odd index numbers or vice versa. In this case, the WTRU may determine cell IDs based on the relation between the PSS sequence ID number of the PSS bin index number.

Referring to FIG. 9, the network may transmit PSS sequences sequentially in bins of odd indexes only or bin of even indexes only, thus allowing for time separation between PSS peaks from WTRU's perspective. For example, bin 1 carries PSS sequence 0 for cell ID 1, bin 3 carriers PSS sequence 1 for cell ID 2, bin 5 carrier sequence ID 2 for cell ID 3, bin 7 carries sequence 0 for cell ID 4, etc . . . .

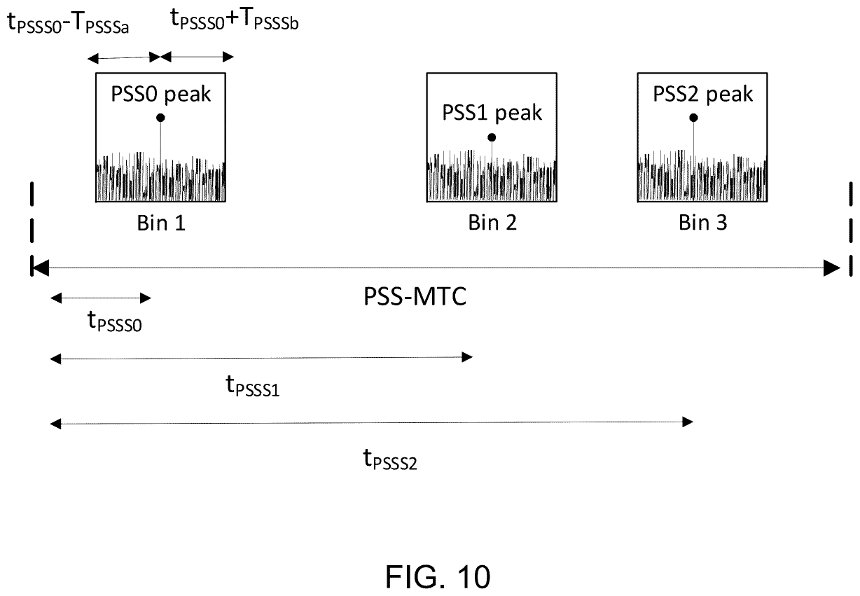

About determination of bin locations, the configuration of the time bins may divide the PSS MTC duration into an arbitrary number of discontinuous bins. Referring to FIG. 10, the center of these bins may depend on the location of the strongest PSS peak(s) for each PSS sequence. For example, for Bin 1, the timing t_{PSS1} of the strongest PSS peak with sequence 0 (PSS1 peak), may define the location of the bin [t_{PSS1}−T_{PSSa} t_{PSS1}+T_{PSSb}], where T_{PSSa}+T_{PSSb} defines the bin duration. Similarly, Bin 2 time-location may be determined by the strongest PSS peak with sequence 1 (PSS1 peak), etc. In yet another alternative bin configuration, a discontinuous Bin 1 may comprise the union of [t_{PSS0}−T_{PSSa}+k·T_{c} t_{PSS0}+T_{PSSb}+k·T_{c}], where k is an integer and T_{c} is the spacing between consecutive parts of the bin. For example, T_{PSSa}+T_{PSSb} may be in the order of at least a typical delay spread, and T_{c} may correspond to a transmission separation of PSS, e.g., an integer number of SC-FDE blocks for a particular symbol rate.

Similarly, the configuration of the frequency bins may divide the PSS MTC bandwidth into an arbitrary number of discontinuous bins. The center of these bins may depend on the location of the strongest PSS peaks for each PSS sequence. For example, for Bin 1, the frequency f_{PSS1} of the strongest PSS peak with sequence 0, defines the location of the bin [f_{PSS1}−F_{PSSa} f_{PSS1}+T_{PSSb}], where F_{PSSa}+F_{PSSb} defines the bin bandwidth. Similarly, Bin 2 frequency location is determined by the strongest PSS peak with sequence 1, etc. If the frequency location of strongest PSS peak with sequence 0 is equal to the frequency location of the strongest PSS peak of sequence 1, only one bin may be defined for both sequences.

About measurement model, considering a PSS MTC of duration T_{PSS-MTC}, a WTRU with J Rx beams may be configured with N bins and M PSS sequences. The WTRU may be configured with corresponding measurement triggering event parameters (metric, threshold, hysteresis, etc.).

When a measurement event is triggered, the WTRU may report the configured measurement results, such as the metric that was used to trigger the event along with other parameters such as detected PSS bin index, sequence Id and/or WTRU Rx beam. The additional information may be useful for the network, e.g., in determining which TRP(s) the WTRU is close to. The network may identify a cell ID based on a PSS measurement report and a PSS bin-to-cell mapping.

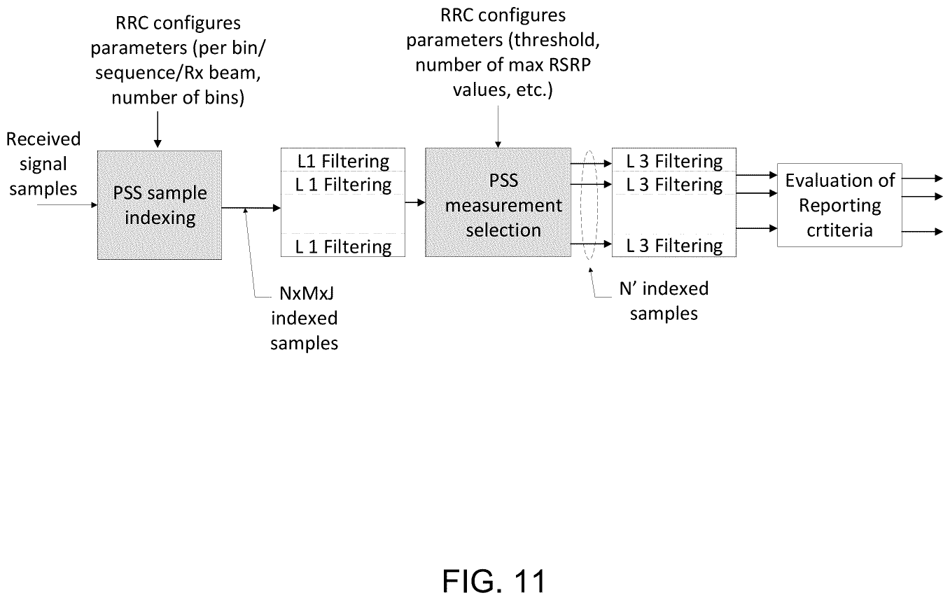

Referring to FIG. 11, the WTRU received signal samples, which may correspond to PSS detection values, may be fed to a “PSS sample indexing” module which indexes samples according to criterion received in RRC configuration. For example, the resulting RSRP measurement samples may be indexed as RSRP_{n,m,j}, where n={1, . . . , N}, m={1, . . . , M}, j={1, . . . , J}. The set of N×M×J indexed samples may be inputted to a bank of L1 filters. Outputs of L1 filters may be inputted to a “PSS measurement selection” module. The configuration of this module may be provided by RRC signaling. The module may apply the received configurations (thresholds, number of reported RSRP values, etc.) to the indexed samples. In the PSS measurement selection module, N′ samples may be selected as follows: (i) N RSRP values, one for each bin n according to max_{m,j}(RSRP_{n,m,j}); (ii) M RSRP values, one for each sequence m according to max_{n,j}(RSRP_{n,m,j}); (iii) J RSRP values, one for each WTRU Rx beam j according to max_{n,m}(RSRP_{n,m,j}); (iv) any combination of the above (e.g., 1 RSRP value according to max_{n,m,j} (RSRP_{n,m,j})); (v) select measurements that are above a certain threshold (e.g., RSRP_{m,j}>Th_{RSRP}). In some cases, the PSS measurement selection may also comprise further operations, such as addition or mean of the selected samples. The addition or mean operation may be performed before L3 filtering, e.g., resulting in a single L3 filter. In some cases, the addition or mean operation may be performed after the L3 filtering.

The samples may be fed to a bank of N′ L3 filters and passed to the “Evaluation of reporting criteria” to check if a measurement reporting event is triggered. In some cases, the PSS measurement selection may be not included in the measurement model. Instead, only PSS-based measurements that are layer 3 filtered are also layer 1 filtered.

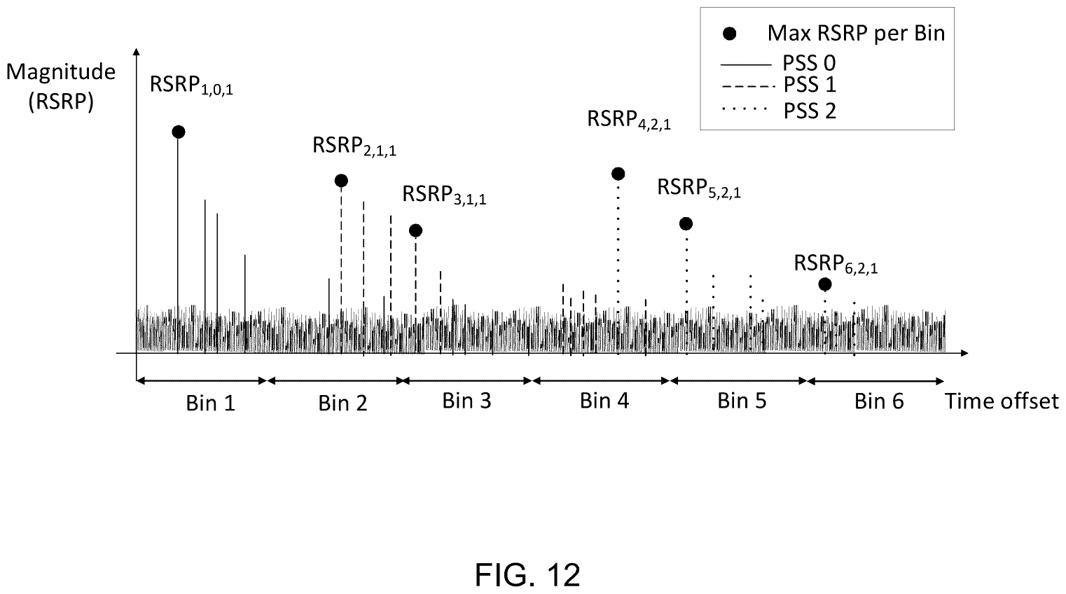

PSS measurement selection may refer to a process of filtering PSS samples between L1 filtering and L3 filtering. This may help bound the number of inputs to L3 filtering and consequently the number of results reported by the WTRU to a base station. The network may configure the WTRU with a “Metric, Event, Report” combination. The following are examples of corresponding measurement metrics, report triggering events and report metrics: (i) Metric M3-1: PSS measurement selection may output the average or total power of PSS peaks above a configured threshold in a time-frequency bin, for a PSS sequence index or across all PSS sequence indexes; (ii) Metric M3-2: PSS measurement selection may output N RSRP measurement samples corresponding to the maximum values in each PSS bin (e.g., RSRPₙ=max_{m,j}(RSRP_{n,m,j}), where n={1, . . . , N}) as illustrated in FIG. 12; (iii) Metric M3-3: PSS measurement selection may output the highest N′ measurement samples of all N RSRP values (e.g., highest N′ from RSRP, where n={1, . . . , N}, and N>N′); (iv) Metric M3-4: PSS measurement selection may output measurement samples that exceed a certain pre-defined threshold (e.g., RSRPₙ>Th_{M3-3}), where n={1, . . . , N}; (v) Event E3: M3-1, M3-2 or M3-3 is above threshold (TH_{E3}). In case of Event E3 is triggered, the WTRU may report R3-1; (vi) Report R3-1: The WTRU may report at least one PSS RSRP measurement and the corresponding bin(s).

Measurement report (e.g., measurement information) may contain per bin measurement results of all bins or a number of the best bins in case of the WTRU is configured to do so by the network. In case of bins are network configured, the WTRU may report the corresponding bin index per the configuration it receives from the network. In case of bins are WTRU determined, the WTRU may assign an arbitrary index to each bin along with its offset from a time reference (e.g., start of the PSS MTC) or a frequency reference.

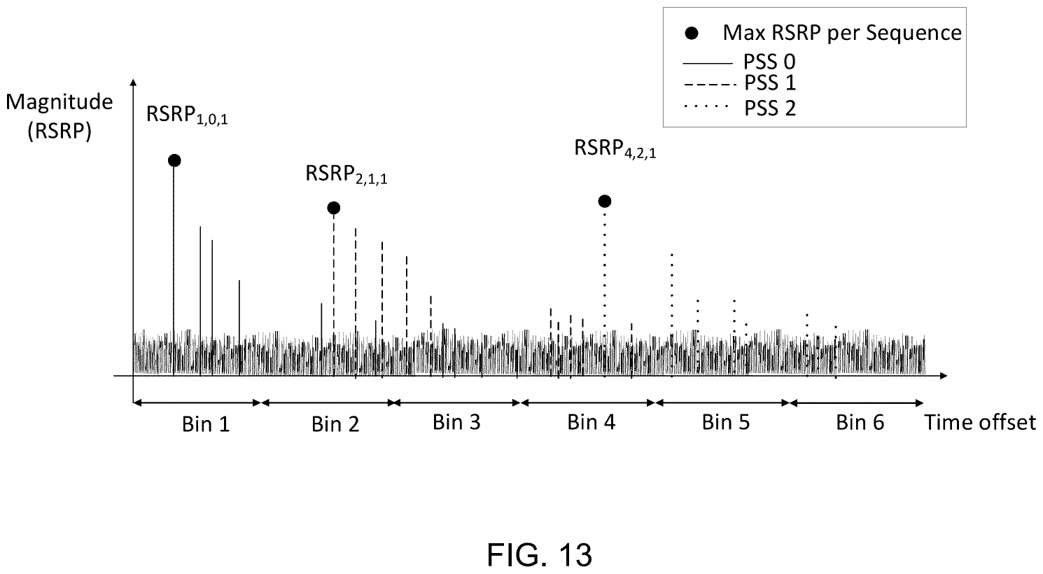

In one embodiment, a WTRU may report RSRP measurements for all PSS sequences. In another embodiment, a WTRU may be configured to report only the highest RSRP value of L3 filtered RSRP measurements. In another embodiment a WTRU may report post L3 filtering measurements that exceed a certain pre-defined threshold. Measurement report (e.g., measurement information) may contain per per-sequence measurement results for all sequences or a number of the best sequences if the WTRU is configured to do so by the network (e.g., gNB). The WTRU may be configured by the network with any “Metric, Event, Report” combination. The following are the corresponding measurement metrics, report triggering events and report metrics: (i) Metric M4-1: PSS measurement selection may output the average or total power of PSS peaks above a configured threshold for each PSS sequence index; (ii) Metric M4-2: PSS measurement selection may output “M” RSRP measurement samples corresponding to the maximum values for each PSS sequence (e.g., RSRPₘ=max_{n,j}(RSRP_{n,mj}), where m={1, . . . , M} as illustrated in FIG. 13; (iii) Metric M4-3: PSS measurement selection may output the highest “N′” measurement samples of all “M” RSRP values (e.g., highest N′ of RSRPₘ, where m={1, . . . , M}, and M>N′); (iv) Metric M4-4: PSS measurement selection may output measurement samples that exceed a certain pre-defined threshold (e.g., RSRPₘ>Th_{M4-3}), where m{1, . . . , M}; (v) Event E4: M4-1, M4-2 or M4-3 may be above threshold (TH_{E4}). In case of Event E4 is triggered, the WTRU may report R4-1; (vi) Report R4-1: The WTRU may report at least one PSS RSRP measurement and the corresponding PSS sequence.

Measurement report (e.g., measurement information) may contain per sequence measurement results of all sequences or a number of the best sequences if the WTRU is configured to do so by the network (e.g., gNB). Along with the reported sequence, the WTRU may report the offset of the corresponding PSS peak from a time reference (e.g., start of the PSS MTC) or a frequency reference.

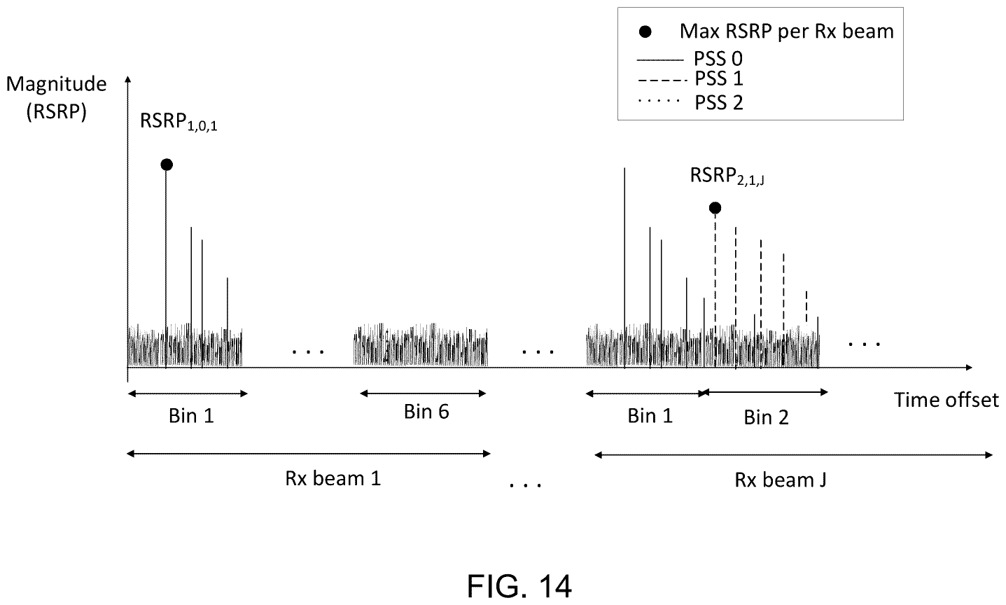

About WTRU Rx-beam-based PSS measurement selection, the WTRU may be configured by the network with any “Metric, Event, Report” combination. The following are the corresponding measurement metrics, report triggering events and report metrics: (i) Metric M5-1: PSS measurement selection may output J RSRP measurement samples corresponding to the maximum values in each PSS bin (e.g., RSRPⱼ=max_{n,m}(RSRP_{n,m,j}), where j={1, . . . , J} as illustrated in FIG. 14; (ii) Metric M5-2: PSS measurement selection may output the highest “N′” measurement samples of all J RSRP values (e.g., highest N′ of RSRPⱼ, where j={1, . . . , J}, and J>N′); (iii) Metric M5-3: PSS measurement selection may output measurement samples that exceed a certain pre-defined threshold (e.g., RSRPⱼ>Th_{M5-3}), where j={1, . . . , J}; (iv) Event E5: M5-1, M5-2 or M5-3 may be above threshold TH_{E5}. In case of Event E5 is triggered, the WTRU may report R5-1; (v) Report R5-1: The WTRU may report at least one PSS RSRP measurement and the corresponding Rx beam.

Measurement report (e.g., measurement information) may contain per Rx beam measurement results of all bins or a number of the best Rx beams in case of the WTRU is configured to do so by the network (e.g. gNB). Along with the reported Rx beam, the WTRU may report the offset of the corresponding PSS peak from a time reference (e.g., start of the PSS MTC) or a frequency reference.

About WTRU bin/sequence/Rx-based PSS measurement selection, the WTRU may be configured by the network with any “Metric, Event, Report” combination. The following are the corresponding measurement metrics, report triggering events and report metrics: (i) Metric M6-1: PSS measurement selection may output a single RSRP measurement sample corresponding to the maximum value in all PSS bins, sequences and from all Rx beams (e.g., RSRP=max_{n,m,j} (RSRP_{n,m,j})); (ii) Metric M6-2: PSS measurement selection may output the highest “N′” measurement samples of all M×N×J RSRP values (i.e., the highest N′ of RSRP_{n,m,j}); (iii) Metric M6-3: PSS measurement selection may output measurement sample(s) that exceed a certain pre-defined threshold (e.g., RSRP_{n,m,j}>Th_{M6-3} or RSRP>Th_{M6-3}); (iv) Event E6: M6-1, M6-2 or M6-3 may be above threshold TH_{E6}. In case of Event E5 is triggered, the WTRU may report R5-1; (v) Report R6-1: The WTRU may report at least one PSS RSRP measurement and the corresponding Rx beam(s).

Measurement reports (e.g. measurement information) may contain M×N×J per bin/per sequence/per WTRU Rx beam measurement results in case of the WTRU is configured to do so by the network (e.g., gNB). Along with the reported results, the WTRU may report the offset of the corresponding peak from a time reference (e.g., start of the PSS MTC) or a frequency reference.

The WTRU may receive from a serving cell a request to inform about its SC-FDE capability. The WTRU may receive from the serving cell a message comprising information indicating a specific parameter in “WTRU capability Enquiry”. For example, the enquiry may include a request to identify any SC-FDE specific radio access technology (RAT). Under each RAT, the enquiry may request information about the supported SC-FDE bands. The WTRU may also receive a request message from the serving cell comprising a request for the WTRU to indicate its support for NR-SC-FDE dual connectivity. The WTRU may also be requested to indicate whether it supports certain NR events when measuring for received RSRP on SC-FDE cell. Additionally, the network may define the supported symbol rate and reference frequencies and request the WTRU to indicate which rate/reference frequency it can support.

About “PSS-based measurement and reporting” capability enquiry, the network may list a set of SC-FDE required/supported features and the WTRU may receive from the network a request to the WTRU to indicate its support for each. For example, the WTRU be enquired to indicate its support for PSS-based measurement and reporting. Furthermore, the WTRU may be requested to indicate a list of sub-features required to support PSS-based measurement and reporting. The list of sub-features may include time-frequency binning, PSS-based measurement, PSS based reporting, and corresponding events.

About WTRU procedure for determining SC-FDE measurement and reporting configurations, the WTRU may receive from the network a measurement configuration which includes measurement gap configurations specific to SC-FDE. These measurement gap configurations may include time domain locations of windows during which the WTRU may perform PSS and SSS based measurements on SC-FDE carriers. New values for measurement gap repetition period, gap offset, measurement gap length and measurement gap timing advance may need to be defined for SC-FDE carrier frequency. The measurement configuration may also include measurement objects for PSS and SSS MTCs. These measurement objects may contain PSS/SSS symbol rates and PSS/SSS MTC configurations (e.g., periodicity, offset and duration). It may also include defined rules for dynamic measurement gap updates.

The PSS and SSS reporting configuration may determine the reference signal (PSS or SSS) to be measured for SC-FDE initial access. It may also determine the measurement report (e.g., measurement information) format, triggering events, triggering criteria and other parameters (thresholds, hysteresis, offsets, etc.). For example, the configuration may define the PSS and SSS-based report format to include the measurement metric, corresponding measurement value, time offset from a reference point (e.g., start of the MTC) in a specific SC-FDE measurement result information element (IE). Additionally, a PSS-based report may include per bin and/or per sequence measurement results and the corresponding bin information (e.g., bin index for the case of network configured bins or time offset for the case of WTRU-determines bins).

In an embodiment, a WTRU may perform PSS measurement and reporting based PSS bins. Specifically, the WTRU may follow the following below steps.

In a first step, the WTRU may be configured by a serving cell, the configuration for PSS-based measurement and reporting may comprise a synchronization frequency, a PSS (e.g., MTC) time window (e.g., time period) configuration, time and frequency bins, PSS-based metrics, events and reporting criteria based on PSS binning, wherein PSS binning may comprise PSS-based event E1.

In a second step, the WTRU may perform PSS detection in the configured PSS (e.g., MTC) time window (e.g., time period) and may determine PSS detection values corresponding to configured metrics. More particularly, the WTRU may determines a first set of strongest PSS peak power for each PSS (e.g., MTC) time and frequency bin. The WTRU may determine the corresponding time offset in relation to the start of the (e.g., MTC) time window (e.g., time period). The WTRU may determine the frequency offset in relation to the synchronization frequency.

In a third step, the WTRU may determine a second set of PSS peaks which is a subset of the first set of strongest peaks and corresponding time/frequency bins.

In a fourth step, in case of/on condition that one or more peaks of the second set trigger event E1, the WTRU may transmit to the network the following PSS-based measurement report including any of: triggering of event E1, the time-frequency bin indexes corresponding to the second set of PSS peaks, per bin time offset relative to the start of the PSS (e.g., MTC) time window (e.g., time period), per bin frequency offset relative to the synchronization frequency and PSS measurement values corresponding to the PSS peaks that triggered event E1.

In another embodiment, a WTRU may perform PSS measurement and reporting based PSS bins, sequences and WTRU Rx beam. More particularly, the WTRU may follow the following below steps:

In a first step, the WTRU may be configured by a serving cell, the configuration for PSS-based measurement and reporting may comprise a synchronization frequency, a PSS (e.g., MTC) time window (e.g., time period) configuration, time and frequency bins, PSS-based metrics, events, and reporting criteria based on PSS bins, sequences and WTRU Rx beam, PSS (e.g., MTC)-measurement gap association and PSS-based event E1 (e.g., comprised in the bin-based event).

In a second step, the WTRU may performs PSS detection in the configured PSS (e.g., MTC) time window (e.g., time period) and determines PSS detection values corresponding to configured metrics. More particularly, the WTRU may determine the strongest PSS peak power for each PSS (e.g., MTC) time and frequency bin. The WTRU may determines the corresponding time offset in relation to the start of the (e.g., MTC) time window (e.g., time period). The WTRU may determine the frequency offset in relation to the synchronization frequency.

In a third step, in case of/on condition that one or more strongest PSS peaks trigger event E1, the WTRU may transmit to the network the following PSS-based measurement report (e.g., measurement information) including any of triggering of event E1, the time-frequency bin indexes corresponding to the second set of PSS peaks, per bin time offset relative to the start of the PSS (e.g., MTC) time window (e.g., time period), per bin frequency offset relative to the synchronization frequency and PSS measurement values corresponding to the PSS peaks that triggered event E1.

In another embodiment, a method for PSS based measurement and reporting, the method being implemented in a WTRU, the method may comprise the following below steps.

In a first step, the WTRU may receive a configuration message from a serving cell, the configuration message comprising information indicating any of (i) a PSS (e.g., MTC) time window (e.g., time period) for a synchronization frequency, (ii) time bin configuration, e.g., a first set of time bins within the PSS (e.g., MTC) time window (e.g., time period), time bin duration, etc . . . , (iii) frequency bin configuration in relation to the synchronization frequency, e.g., a first set of frequency bins, such as a bin for small frequency (e.g., Doppler) offset, a bin for large positive frequency offset and a bin for large negative frequency offset, (iv) one or bin-based (e.g., segment-based) events with corresponding criteria that may comprise PSS-based events criteria, (v) PSS-based reporting configuration, and (vi) a configuration of a set of PSS filtering thresholds. In case of both time bins and frequency bins are configured, their combination may constitute a first set of time-frequency bins. In the steps below, “time-frequency bins” may also correspond to “time bins”, e.g., if frequency bins are not configured.

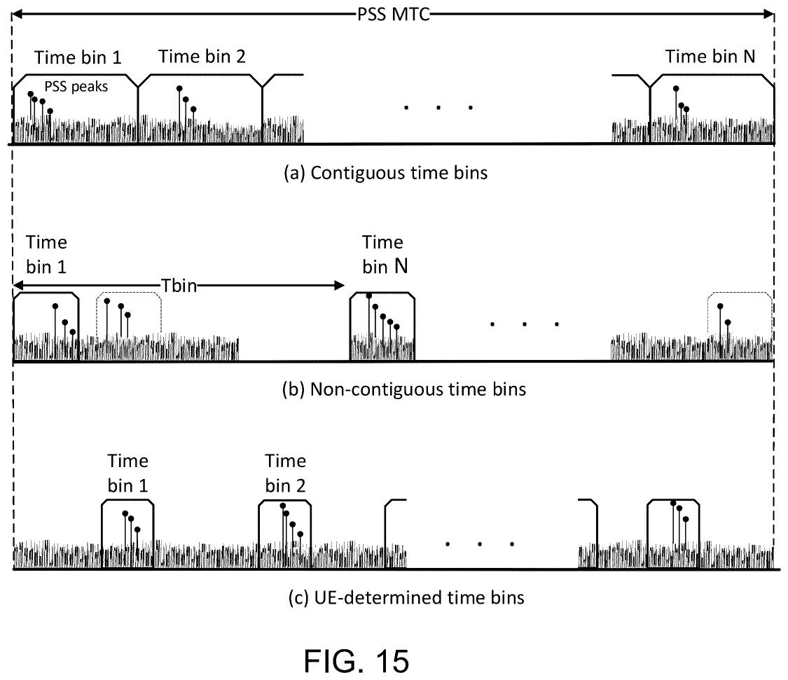

About time bin configuration, referring to FIG. 15, the upper figure (a) in FIG. 15 illustrates a set of contiguous non-overlapping time bins that together span the PSS (e.g., MTC) time window (e.g., time period). The middle figure (b) in FIG. 15 illustrates a set of non-contiguous time bins that together do not span all of the PSS (e.g., MTC) time window (e.g., time period), and Tbin may illustrate a configurable time offset for the Nth bin. The lower figure (c) in FIG. 15 illustrates a set of WTRU-determined time bins),

In a second step, the WTRU may perform PSS detection in the PSS (e.g., MTC) time window (e.g., time period) for the synchronization frequency, and may determine PSS detection values, e.g., PSS correlation peaks with corresponding powers, time offsets in relation to the start of the (e.g., MTC) time window (e.g., time period), frequency offsets in relation to the synchronization frequency, and PSS sequence indexes.

In a third step, the WTRU may determine a PSS filtering threshold based at least on the determined PSS detection values. Then the WTRU may apply the determined PSS filtering threshold such that for (e.g., each of) the determined PSS detection values below the selected PSS filtering threshold, the WTRU remove them or sets them to zero. The PSS filtering threshold may be determined (e.g., selected) from the configured set of PSS filtering thresholds, if configured, or a predefined set of PSS filtering thresholds.

For determination of metrics for criterion evaluation and reporting, in a fourth step, the WTRU may determine a second set of time-frequency bins based on the PSS detection values. The second set of time-frequency bins may be a subset of the first set of time-frequency bins, and corresponding PSS measurement value(s). As an example, a PSS measurement value may correspond to the power of the strongest PSS peak in a time-frequency bin. As another example, a PSS measurement value may correspond to the total power of PSS peaks (above a threshold) in a time-frequency bin, for a PSS sequence index or across all PSS sequence indexes. The second set of time-frequency bins may comprise the M time-frequency bins corresponding to the highest measurement values, wherein M may be configurable or determined by the WTRU. In the case of WTRU-determined bins, the WTRU may not select the second set of bins from a pre-configured first set. Instead, the WTRU may determine the second set of bins based on the corresponding PSS measurement value(s), e.g., the bins that include the most PSS power (above a threshold).

In a fifth step, the WTRU may determine if the PSS measurement value(s) for the second set of time-frequency bins meets one of the configured bin-based (e.g., segment-based) event criteria (e.g., comprising PSS-based event criteria). An event criterion may take multiple PSS measurement values for multiple time-frequency bins into account, for example the total PSS measurement value across the second set of time bins.

If an event has been triggered (e.g., if PSS at least one measurement value for the second set of time-frequency bins meets one of the configured bin-based (e.g., segment-based) event criteria (e.g., comprising PSS-based event criteria), the WTRU may transmit to the network the following PSS-based report including any of: the second set of time-frequency bins (e.g., the corresponding time-frequency bin indexes), time bin offset(s) compared to start of (e.g., MTC) time window (e.g., time period) (in case of WTRU-determined bins), frequency bin offset(s) compared to synchronization frequency (in case of WTRU-determined bins), the PSS measurement values corresponding to the second set of time-frequency bins, the PSS sequence indexes corresponding to the PSS measurement values, and the selected PSS filtering threshold (e.g., a PSS filtering threshold index).

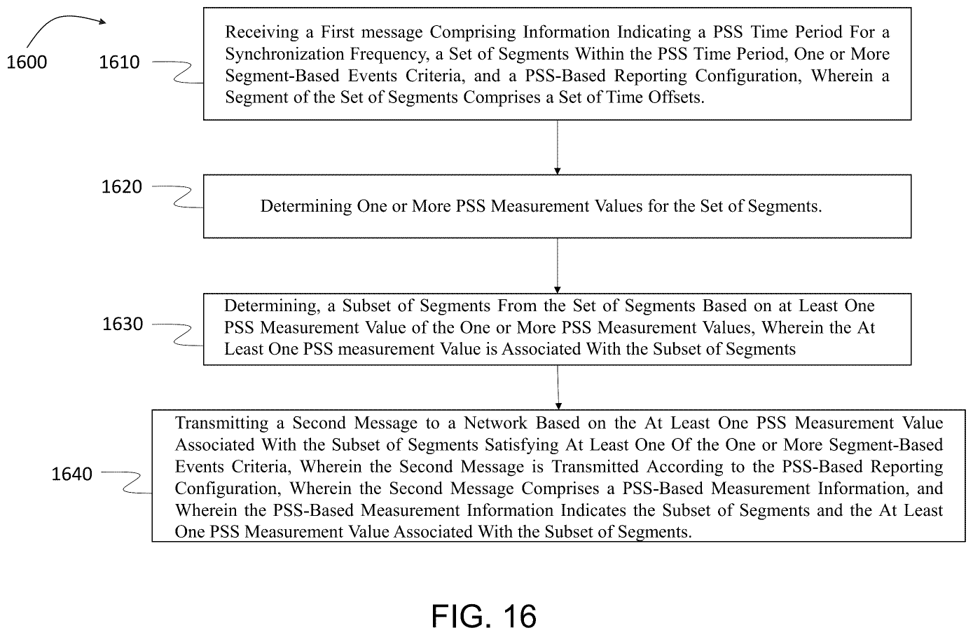

Referring to FIG. 16, a method 1600, implemented in a WTRU, for reporting PSS measurements, is shown.

The method 1600 may comprise a step wherein the WTRU may receive 1610 a first message comprising information (e.g., configuration information) indicating a primary synchronization signal (PSS) time period (e.g., an MTC time window) for a synchronization frequency, a set of segments within the PSS time period, one or more segment-based events criteria, and a PSS-based reporting configuration, wherein a segment of the set of segments may comprise a set of time offsets. The one or more segment-based events criteria may be based on PSS events, such that the one or more segment-based events criteria may correspond to PSS-based event criteria. The segment may further comprise a set of frequency offsets. In other words, the segment may be defined as a time-bin or as time-frequency bin.

The method 1600 may comprise a step wherein the WTRU may determine 1620 one or more PSS measurement values for the set of segments. The WTRU may determine 1630 a subset of segments from the set of segments based on at least one PSS measurement value of the one or more PSS measurement values, wherein the at least one PSS measurement value is associated with the subset of segments.

The one or more PSS measurement values may comprise one or more power values of one or more PSS peaks that occurred during at least one segment of the set of segments, and wherein the at least one of the one or more segment-based events criteria comprises a highest value of at least one power value of the one or more power values, wherein the at power value corresponds to a respective at least one PSS peak of the one or more PSS peaks satisfies a first threshold. The first threshold may be a configured or a preconfigured threshold. Satisfying the first threshold may correspond to be greater than (or less than) or greater and equal.

Alternatively, the one or more PSS measurement values may comprise a total power value of the PSS during at least one segment of the set of segments, and wherein the at least one of the one or more segment-based events criteria comprises the total power value of the satisfies a second threshold. The second threshold may be a configured or a preconfigured threshold. Satisfying the second threshold may correspond to be greater than (or less than) or greater and equal. The method 1600 may comprise a step wherein the WTRU may determine the total power value of the PSS by summing a plurality of power values of a plurality of PSS peaks above a third threshold.

The method 1600 may comprise a step wherein the WTRU may transmit 1640 a second message to a network based on the at least one PSS measurement value associated with the subset of segments satisfies at least one of the one or more segment-based events criteria, wherein the second message is transmitted according to the PSS-based reporting configuration, wherein the second message comprises a PSS-based measurement information, and wherein the PSS-based measurement information indicates the subset of segments and the at least one PSS measurement value associated with the subset of segments.

Transmitting the second message to the network may be based on the at least one PSS measurement value associated with the subset of segments greater (or equal) than (or less than) at least one of the one or more segment-based events criteria.

The method 1600 may further comprise a step wherein, the at least one PSS measurement value associated with the subset of segments may comprises a plurality of PSS measurement values associated with a plurality of the subset of segments, and wherein transmitting the second message to the network may comprise transmitting the second message to the network based on the plurality of PSS measurement values satisfying the at least one of the one or more segment-based events criteria.

The method 1600 wherein determining one or more PSS measurement values by the WTRU may comprise: performing PSS detection during the PSS time period for the synchronization frequency and determining the one or more PSS measurement values based on the PSS detection.

The method 1600 wherein determining the subset of segments by the WTRU may comprise: determining the subset of segments based on the one or more PSS measurements values.

The one or more PSS measurement values may comprise any of one or more PSS (e.g., correlation) peaks with corresponding power values, one or more time offsets in relation to a start of the PSS time period, one or more frequency offsets in relation to the synchronization frequency, and one or more PSS sequence indexes.

Performing PSS detection by the WTRU may comprise determining, by the WTRU, one or more PSS detection values, wherein the information further indicates (e.g., a configuration of) a set of PSS filtering thresholds. The method may comprise a step wherein the WTRU may: determine a PSS filtering threshold and one or more filtered PSS detection values based on the one or more PSS detection values, wherein the one or more filtered PSS detection values may correspond to a respective one or more of the one or more PSS detection values that are above the PSS filtering threshold; and determine the subset of the set of segments and the one or more PSS measurement values based on the filtered PSS detection values.

The PSS-based measurement information may indicate the PSS filtering threshold.

The information may indicate a configuration associated with the set of segments, wherein the configuration associated with the set of segments may comprise any of configuration information indicating the set of segments, a first time-frequency segment corresponding to a positive frequency offset from the synchronization frequency, and a second time-frequency segment corresponding to a negative frequency offset from the synchronization frequency.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

1. A method, implemented in a wireless transmit/receive unit (WTRU), the method comprising:
receiving a first message comprising information indicating a primary synchronization signal (PSS) time period for a synchronization frequency, a set of segments within the PSS time period, one or more segment-based events criteria, and a PSS-based reporting configuration, wherein a segment of the set of segments comprises a set of time offsets;
determining one or more PSS measurement values for the set of segments;
determining, a subset of segments from the set of segments based on at least one PSS measurement value of the one or more PSS measurement values, wherein the at least one PSS measurement value is associated with the subset of segments; and
transmitting a second message to a network based on the at least one PSS measurement value associated with the subset of segments satisfying at least one of the one or more segment-based events criteria, wherein the second message is transmitted according to the PSS-based reporting configuration, wherein the second message comprises a PSS-based measurement information, and wherein the PSS-based measurement information indicates the subset of segments and the at least one PSS measurement value associated with the subset of segments.

2. The method of claim 1, wherein the segment further comprises a set of frequency offsets.

3. The method of claim 1, wherein the one or more PSS measurement values comprise one or more power values of one or more PSS peaks that occurred during at least one segment of the set of segments, and wherein the at least one of the one or more segment-based events criteria comprises a highest value of at least one power value of the one or more power values, wherein the at power value corresponds to a respective at least one PSS peak of the one or more PSS peaks satisfies a first threshold.

4. The method of claim 1, wherein the one or more PSS measurement values comprises a total power value of the PSS during at least one segment of the set of segments, and wherein the at least one of the one or more segment-based events criteria comprises the total power value of the PSS satisfies a second threshold.

5. The method of claim 4, comprising determining the total power value of the PSS by summing a plurality of power values of a plurality of PSS peaks above a third threshold.

6. The method of claim 1, wherein the at least one PSS measurement value associated with the subset of segments comprises a plurality of PSS measurement values associated with a plurality of the subset of segments, and wherein transmitting the second message to the network comprises transmitting the second message to the network based on the plurality of PSS measurement values satisfying the at least one of the one or more segment-based events criteria.

7. The method of claim 1,
wherein determining one or more PSS measurement values comprises:
performing PSS detection during the PSS time period for the synchronization frequency; and
determining the one or more PSS measurement values based on the PSS detection; and
wherein determining the subset of segments comprises:
determining the subset of segments based on the one or more PSS measurements values.

8. The method of claim 7, wherein the one or more PSS measurement values comprise any of one or more PSS peaks with corresponding power values, one or more time offsets in relation to a start of the PSS time period, one or more frequency offsets in relation to the synchronization frequency, and one or more PSS sequence indexes.

9. The method of claim 7, wherein performing PSS detection comprises determining one or more PSS detection values, wherein the information further indicates a set of PSS filtering thresholds, the method comprising:
determining a PSS filtering threshold and one or more filtered PSS detection values based on the one or more PSS detection values, wherein the one or more filtered PSS detection values correspond to a respective one or more of the one or more PSS detection values that are above the PSS filtering threshold; and
determining the subset of the set of segments and the one or more PSS measurement values based on the filtered PSS detection values.

10. The method of claim 9, wherein the PSS-based measurement information indicates the PSS filtering threshold.

11. The method of claim 1, wherein the information indicates a configuration associated with the set of segments, wherein the configuration associated with the set of segments comprises any of configuration information indicating the set of segments, a first time-frequency segment corresponding to a positive frequency offset from the synchronization frequency, and a second time-frequency segment corresponding to a negative frequency offset from the synchronization frequency.

12. A wireless transmit/receive unit (WTRU) comprising a processor, a transmitter, a receiver and a memory, and configured to:
receive a first message comprising information indicating a primary synchronization signal (PSS) time period for a synchronization frequency, a set of segments within the PSS time period, one or more segment-based events criteria, and a PSS-based reporting configuration, wherein a segment of the set of segments comprises a set of time offsets;
determine one or more PSS measurement values for the set of segments;
determine, a subset of segments from the set of segments based on at least one PSS measurement value of the one or more PSS measurement values, wherein the at least one PSS measurement value is associated with the subset of segments; and
transmit a second message to a network based on the at least one PSS measurement value associated with the subset of segments satisfying at least one of the one or more segment-based events criteria, wherein the second message is transmitted according to the PSS-based reporting configuration, wherein the second message comprises a PSS-based measurement information, and wherein the PSS-based measurement information indicates the subset of segments and the at least one PSS measurement value associated with the subset of segments.

13. The WTRU of claim 12, wherein the segment further comprises a set of frequency offsets.

14. The WTRU of claim 12, wherein the one or more PSS measurement values comprise one or more power values of one or more PSS peaks that occurred during at least one segment of the set of segments, and wherein the at least one of the one or more segment-based events criteria comprises a highest value of at least one power value of the one or more power values, wherein the at power value corresponds to a respective at least one PSS peak of the one or more PSS peaks satisfies a first threshold.

15. The WTRU of claim 12, wherein the one or more PSS measurement values comprises a total power value of the PSS during at least one segment of the set of segments, and wherein the at least one of the one or more segment-based events criteria comprises the total power value of the PSS satisfies a second threshold.

16. The WTRU of claim 15, configured to determine the total power value of the PSS by summing a plurality of power values of a plurality of PSS peaks above a third threshold.

17. The WTRU of claim 12, wherein the at least one PSS measurement value associated with the subset of segments comprises a plurality of PSS measurement values associated with a plurality of the subset of segments, and wherein transmitting the second message to the network comprises transmitting the second message to the network based on the plurality of PSS measurement values satisfying the at least one of the one or more segment-based events criteria.

18. The WTRU of claim 12 configured to:
wherein determining one or more PSS measurement values comprises:
performing PSS detection during the PSS time period for the synchronization frequency; and
determining the one or more PSS measurement values based on the PSS detection; and
wherein determining the subset of segments comprises:
determining the subset of segments based on the one or more PSS measurements values.

19. The WTRU of claim 18, wherein the one or more PSS measurement values comprise any of one or more PSS peaks with corresponding power values, one or more time offsets in relation to a start of the PSS time period, one or more frequency offsets in relation to the synchronization frequency, and one or more PSS sequence indexes.

20. The WTRU of claim 18, wherein performing PSS detection comprises determining one or more PSS detection values, and wherein the information further indicates a set of PSS filtering thresholds, the WTRU being configured to:
determine a PSS filtering threshold and one or more filtered PSS detection values based on the one or more PSS detection values, wherein the one or more filtered PSS detection values correspond to a respective one or more of the one or more PSS detection values that are above the PSS filtering threshold; and
determine the subset of the set of segments and the one or more PSS measurement values based on the filtered PSS detection values.
